(19) United States
(12) Patent Application Publication
(10) Pub. No.: US 2013/0304712 A1
(43) Pub. Date: Nov. 14, 2013

(54) SYSTEM AND METHOD FOR VALIDATION

(71) Applicants: Paul Meijer, Seattle, WA (US); Mark Helkamp, Bothell, WA (US)

(72) Inventors: Paul Meijer, Seattle, WA (US); Mark Helkamp, Bothell, WA (US)

(73) Assignee: THEPLATFORM FOR MEDIA, INC., Seattle, WA (US)

(21) Appl. No.: 13/469,684

(22) Filed: May 11, 2012

(51) Int. Cl. G06F 17/30

(52) U.S. Cl. 707/694; 707/E17.001

(57) ABSTRACT

Systems and methods for validation are disclosed. In an aspect, a method can comprise receiving a selection of a validation rule, the validation rule including a validation element, receiving a selection of a triggering event associated with the validation rule, and validating data using the validation rule and in response to the triggering event.

### BACKGROUND

Currently, content can be provided to a user though any number of devices. Content can comprise data fields such as headers and/or metadata that define attributes of the content. In certain instances, the data fields must be validated in order to allow processing of the content. Typically, validation procedures are hard-coded into a particular desired stage of the media lifecycle. For instance, if a description is required and cannot be longer than 100 characters, the media creation process can be limited to only allow descriptions of 100 characters or less. However, if subsequent to creation, the media is edited, the media editing process must include an independent validation procedure that is to be implemented during an editing process.

One shortcoming of existing validation solutions is that media creation and modification processes are “polluted” by providing knowledge about validation rules. In other words, although the exact same validation was applied both during media creation and media editing, the commonality of the validations is not expressed in any way. Also, if a first user wants a certain metadata field to be no longer than 100 characters and a second user wants the metadata field to be no longer than 50 characters, two separate media creation workflows are needed to satisfy both customers. Accordingly, conventional approaches can neither scale nor be cost-effective in a multi-tenant video management system.

### SUMMARY

It is to be understood that both the following general description and the following detailed description are exemplary and explanatory only and are not restrictive. Provided are methods and systems for validation. As an example, the systems and methods can be used to validate media metadata.

Media metadata describe the properties and attributes of media, such as the title, description, category, tags, and the duration of the media can be offered through a video portal to end users (e.g., a website or a set top box). There are several stages during a media lifecycle in which validation can occur. These stages include, but are not limited to, when media is first created, when media is edited, before media is released to end user video portals, before media is distributed to other entities (e.g., companies) for release to their end user video portals, and the like. Furthermore, there are different types of validation that can be applied to many fields. Examples of validation types include, but are not limited to, “a field is required,” “a field cannot have more than a certain number of characters,” and “field must be a valid date.”

In one aspect, the systems and methods of the present disclosure separate the type of validation from the data field or metadata field that needs to be validated and associates a particular stage of the media with a particular validation. Accordingly, the system and methods of the present disclosure can implement validation procedures without being aware of which fields are being validated and which validation procedures are being applied in a particular customer/client/user workflow.

In an aspect, a method can comprise receiving a selection of a validation rule or implementation of validation procedures to one or more prescribed data fields. As an example, the validation rule can comprise a validation element defining a comparator or value to applied against one or more data fields. As a further example, the validation rule can comprise a template or preformed instruction, whereby the template can call for one or more validation elements to be applied to the same templated set of instructions or rules. The method can further comprise receiving a selection of a triggering event associated with the validation rule. In an aspect, data can be validated using the validation rule and in response to the triggering event.

In another aspect, a method can comprise receiving content having a parameter and applying an operation to the content. As an example, the operation can trigger a step of validating the parameter using a validation rule and in response to the operation, wherein the validation rule is associated with the operation.

In a further aspect, a system can comprise a memory storing one or more validation templates. A process can be in communication with the memory. The processor can be configured receive a selection of one or more of the validation templates. As an example, the validation templates can comprise a validation element. The processor can be configured to receive a selection of a triggering event associated with the validation template. Accordingly, data can be validated by the processor using the validation rule and in response to the triggering event.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary network;

FIG. 2 is a block diagram of an exemplary network;

FIG. 3 is an illustration of an exemplary validation element and validation rules;

FIG. 4 is a flow chart of an exemplary method;

FIG. 5 is a flow chart of an exemplary method;

FIG. 6 is a flow chart of an exemplary method; and

FIG. 7 is a block diagram of an exemplary computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As described in greater detail below, a system and network can be configured to control presentation of various types of content on a plurality of devices. In an aspect, validation elements and/or validation rules can be processed to determine if and/or how a particular content should be transmitted and/or rendered to a device.

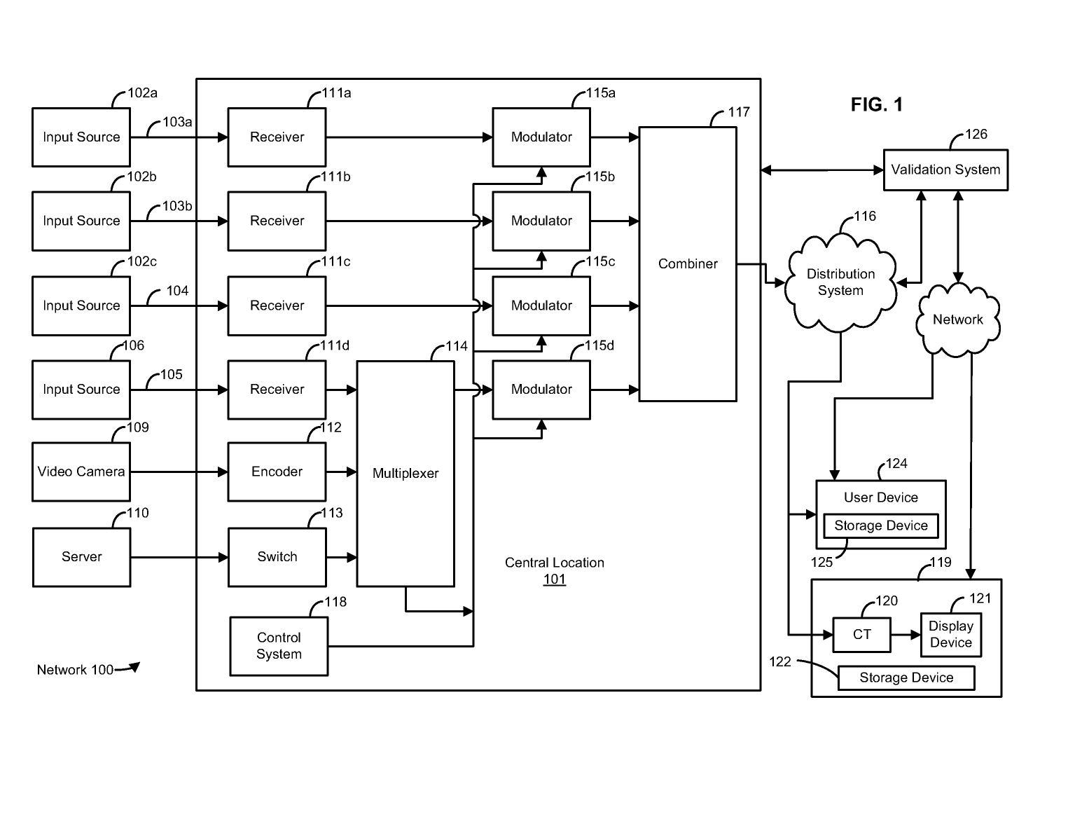

FIG. 1 illustrates various aspects of an exemplary network in which the present methods and systems can operate. The present disclosure relates to systems and methods for processing validation and/or controlling content presentation. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The network 100 can comprise a central location 101 (e.g., a headend, a processing center, etc.), which can receive content (e.g., data, input programming, and the like) from multiple sources. The central location 101 can combine the content from the various sources and can distribute the content to user (e.g., subscriber) locations (e.g., location 119) via distribution system 116.

In an aspect, the central location 101 can create content or receive content from a variety of sources 102a, 102b, 102c. The content can be transmitted from the source to the central location 101 via a variety of transmission paths, including wireless (e.g. satellite paths 103a, 103b) and terrestrial path 104. The central location 101 can also receive content from a direct feed source 106 via a direct line 105. Other input sources can comprise capture devices, such as a video camera 109 or a server 110. The signals provided by the content sources can include, for example, a single content item or a multiplex that includes several content items. In an aspect, the central location 101 can create and/or receive application, such as interactive applications. Such applications can be related to a particular content.

The central location 101 can comprise one or a plurality of receivers 111a, 111b, 111c, 111d that are each associated with an input source. For example, MPEG encoders such as encoder 112, are included for encoding local content or a video camera 109 feed. A switch 113 can provide access to server 110, which can be a Pay-Per-View server, a data server, an internet router, a network system, a phone system, and the like. Some signals may require additional processing, such as signal multiplexing, prior to being modulated. Such multiplexing can be performed by multiplexer (mux) 114.

The central location 101 can comprise one or a plurality of modulators, 115a, 115b, 115c, and 115d, for interfacing to the distribution system 116. The modulators can convert the received content into a modulated output signal suitable for transmission over the distribution system 116. The output signals from the modulators can be combined, using equipment such as a combiner 117, for input into the distribution system 116.

A control system 118 can permit a system operator to control and monitor the functions and performance of network 100. The control system 118 can interface, monitor, and/or control a variety of functions, including, but not limited to, the channel lineup for the television system, billing for each user, conditional access for content distributed to users, and the like. Control system 118 can provide input to the modulators for setting operating parameters, such as system specific MPEG table packet organization or conditional access information. The control system 118 can be located at central location 101 or at a remote location.

The distribution system 116 can distribute signals from the central location 101 to user locations, such as user location 119. The distribution system 116 can be an optical fiber network, a coaxial cable network, a hybrid fiber-coaxial network, a wireless network, a satellite system, a direct broadcast system, or any combination thereof. There can be a multitude of user locations connected to distribution system 116. At user location 119, there may be an interface comprising a decoder 120, such as a gateway or communications terminal (CT) that can decode, if needed, the signals for display on a display device 121, such as on a television set (TV) or a computer monitor. Various wireless devices may also be connected to the network at, or proximate, user location 119. Those skilled in the art will appreciate that the signal can be decoded in a variety of equipment, including an CT, a fixed or mobile computing device, a TV, a monitor, or satellite receiver. In an exemplary aspect, the methods and systems disclosed can be located within, or performed on, one or more wireless device, CT's 120, display devices 121, central locations 101, DVR's, home theater PC's, and the like. As an example, a storage device 122 can be in communication with one or more of the CT 120, the display device 121, and the central location 101 to send/receive content therebetween. As a further example, the storage device 122 can be located remotely from the user location 119, such as a network storage.

In an aspect, user location 119 is not fixed. By way of example, a user can receive content from the distribution system 116 on a mobile device, such as a laptop computer, PDA, smartphone, GPS, vehicle entertainment system, portable media player, and the like.

In an aspect, a user device 124 can receive signals from the distribution system 116 for rendering content on the user device 124. As an example, rendering content can comprise providing audio and/or video, displaying images, facilitating an audio or visual feedback, tactile feedback, and the like. However, other content can be rendered via the user device 124. In an aspect, the user device 124 can be a CT, a set-top box, a television, a computer, a smartphone, a laptop, a tablet, a multimedia playback device, a portable electronic device, and the like. As an example, the user device 124 can be an Internet Protocol compatible device for receiving signals via a network such as the Internet or some other communications network for providing content to the user. It is understood that other display devices and networks can be used. It is further understood that the user device 124 can be a widget or a virtual device for displaying content in a picture-in-picture environment such as on the display device 121, for example. As an example, a storage device 125 can be in communication with one or more of the user device 124 and the central location 101 to send/receive content therebetween. As a further example, the storage device 125 can be located remotely from the user device 124, such as a network storage medium.

In an aspect, a validation system 126 or device (e.g., a computing device configured for validation, metadata validation mechanism, etc.) can be in communication with one or more of the CT 120 and the user device 124 (or other devices) to determine validation for a particular parameter, rule, operation, user and/or device. In an aspect, a service provider can offer certain rules (e.g., validation rule) or parameters associated with the data and/or content. As an example, the rules and/or parameters can control how data is processed. As a further example, rules and/or parameters can define attributes of validated data. Such attributes can include number of characters in a particular field of data, string pattern matching, length of time of content relating to data, bit-rate associated with content, classification of data, category of content, content rating, enforcement of content availability windows, valid decimal, integer, or currency formats, enforcement of read-only state, required fields, and conditional enforcement where the field attributes of one field are the pre-condition for checking for field attributes in another field or fields, and the like.

In an aspect, a system and network can be used to process data such as metadata. As an example, the data can be processed for validation against a pre-defined rule, operator, or comparator. As a further example, the processed data can be related to content transmitted to a particular user and/or device.

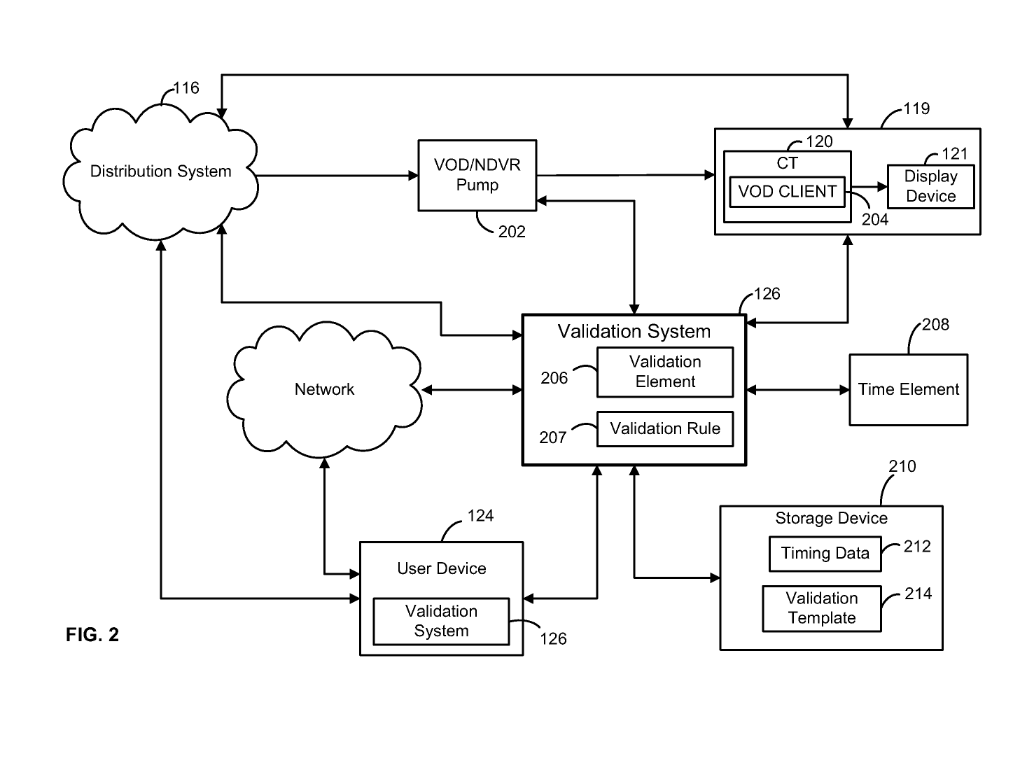

In an aspect, FIG. 2 illustrates various aspects of an exemplary system in which some of the disclosed methods and systems can operate. As an example, the distribution system 116 can communicate with the CT 120 or other content processing device at the user location 119 via, for example, a linear transmission. As a further example, the distribution system 116 can transmit signals to a video-on-demand (VOD) pump 202 or network digital video recorder pump for processing and delivery to the user location 119.

In an aspect, the CT 120, such as a gateway, termination point, or a set-top box, can comprise a software component such as VOD client 204 to communicate with a VOD server (e.g., server 110). The VOD client 204 can communicate requests to the VOD server or a VOD management system in communication with the VOD server to configure the VOD pump 202 to transmit content to the CT 120 for display to a user. Other content distribution systems can be used to transmit content signals to the user location 119. The foregoing and following examples of video transmissions are also applicable to transmission of other data. As an example, content can be received and stored for subsequent playback.

In an aspect, the user device 124 can receive content from the distribution system 116, the Internet Protocol network, such as the Internet, and/or a communications network such as a cellular network, for example. Other network and/or content sources can transmit content to the user device 124. As an example, the user device 124 can receive streaming data, audio and/or video for playback to the user. As a further example, the user device 124 can receive user experience (UX) elements, such as widgets, applications, and content for display via a human-machine interface. In an aspect, user device 124 can be disposed inside or outside the user location 119. As an example, content can be received and stored for subsequent playback.

In an aspect, the validation system 126 can be in communication with the distribution system 116, the CT 120, the user device 124, a local or public network such as the Internet, and/or a communication network to receive information relating to content being delivered to a particular user. As an example, other communications elements, such as software, virtual elements, computing devices, router devices, and the like, can comprise or serve as validation system 126. As a further example, the validation system 126 can process validation elements, rules, and/or parameters associated with content and/or programming to determine the processing of data and presentation to a user or device, as described in further detail herein. In an aspect, the validation system 126 can be disposed remotely from the user location 119. However, the validation system 126 can be disposed anywhere, including at the user location 119, to reduce network latency, for example.

In an aspect, the validation system 126 can comprise one or more validation elements 206. As an example, one or more validation elements 206 can define characters, data fields, classifications, parameters, characteristics, and/or pre-defined limitations or requirements for a particular data. In an aspect, validation elements 206 can represent an abstract validation test or comparison. As an example, a validation test can be defined by a comparator, code, and/or script (e.g., Groovy script or similar) that acts on a media object or content. As a further example, a global required field validator can comprise a script that evaluates whether a particular media object field has a value. A rule that can implement one or more validation elements 206 can specify which data field (e.g., media object field) is evaluated (e.g., by the script).

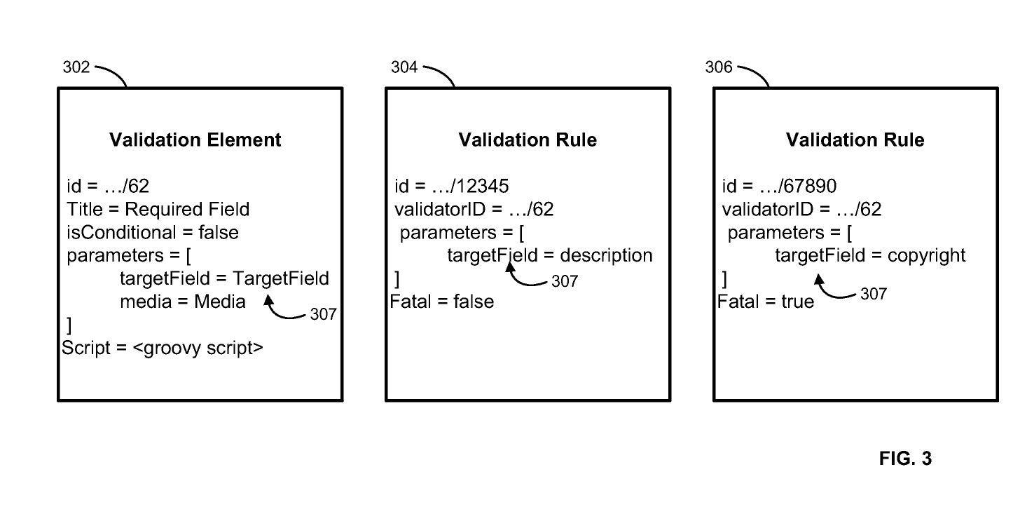

As an example, in FIG. 3, a validation element 302 can represent an abstract validation function of fields with certain data types (such as string, dates, and the like). As shown, the validation element 302 comprises an identifier for distinguishing the validation element 302 from other elements. In an aspect, FIG. 3 illustrates examples of two validation rules 304, 306 that implement a required field validator (e.g., validation element 302). As shown, each validator Id field of the respective validation rule 304, 306 is set with the id of the validation element 302 that is to be implemented.

In an aspect, each validation script can act on one or more media-related parameters. The script's parameter names and data types can be specified in a parameters map of the validation element 302. Each script can act on a media object, but a script can also define one or more configurable parameters. As an example, a configurable parameter can be a parameter that is set with a specific value by each implementing rule (e.g., validation rules 304, 306).

As an example, the global required field validator includes a media parameter and a configurable parameter (e.g., target field 307). Each validation rule that implements the global required field validator can define a value for the target field 307 parameter. Accordingly, the specified media object field is the field that can be evaluated by the script when that validation rule is applied. In FIG. 3, for example, one of the validation rules 304 is configured to evaluate a description field, while the other validation rule 306 is configured to evaluate a copyright field. Accordingly, when the validation rule 304 is applied to a particular validation element 302, the parameter or target field to which the rule applies is a value in the description field Similarly, when the validation rule 306 is applied to a particular validation element 302, the parameter or target field to which the rule applies is a value in the description field. In an aspect, validation rules 304, 306 can be configured to evaluate any parameter or field.

When rules (e.g., validation rules 304, 306) are applied to media, validation will succeed only if the media has a value in its description or copyright field, respectively. If validation fails, the outcome of that failure is determined by the fatal field of the respective validation rule 304, 306. If fatal is set to true, the operation can be canceled when media does not successfully validate. If fatal is set to false, a warning can be generated but the validation failure is not fatal.

In an aspect, the validation system 126 can comprise one or more validation rules 304, 306. As an example, validation rules 304, 306 can comprise, invoke, and/or reference one or more validation elements such as validation element 302. As shown, the validation rule 304 comprises an identifier for distinguishing the validation rule 304 from other rules or parameters. As an example, the validation rule 304 can comprise an implementation of one or more validation elements 302 to a particular data or data field.

As a further example, one or more validation elements 206, 302 can be used to define data processing and/or other functions such as adding, removing, or editing media. As a further example, the validation elements 206, 302 can be used both when adding and editing media.

In an aspect, one or more validation elements 206, 302 can represent a “required field,” for example, as illustrated below:

| Field | Value |
|---|---|
| Title | Required Field |
| parameters | [Media media, TargetField field] |
| description | Validates that a value is provided for a media field |
| exception | The field “[targetField]” is required |

The required field or required field function can validate that a data field (e.g., media field) has a particular value. As an example, data and/or data fields can comprise validations for strings, non-empty strings ignoring whitespace, Date/DateOnly/Time, universal resource identifiers, arrays, maps and the like.

In an aspect, one or more validation elements 206, 302 can represent an “evaluate length” function, for example, as illustrated below:

| Field | Value |
|---|---|
| title | Evaluate Length |
| parameters | [Media media, Target targetField, Operator operator, |
| | Integer integer] |
| description | Validates that the media field has a certain length |
| exception | >=: The [targetField] must be at least [integer] characters |
| | long |
| | >: The [targetField] must be more than [integer] characters |
| | long |
| | <=: The [targetField] must be no more than [integer] |
| | characters long |
| | <: The [targetField] must be less than [integer] characters |
| | long |
| | =: The [targetField] must be exactly [integer] characters |
| | long |

The evaluate length function can validate that a data field length compares to or matches a certain pre-defined length. As an example, an operator can be provided as the comparison operator against a provided integer value. As a further example, two values on the same field can be used to create range comparisons (e.g., 10<=title<50 as a range for characters in a title field).

In an aspect, one or more validation elements 206, 302 can represent an “is a number” function, for example, as illustrated below:

| Field | Value |
|---|---|
| title | Is a Number |
| parameters | [Media media, TargetField targetField] |
| description | Validates that the value provided can be converted to |
| | a number |
| exception | The [targetField] field must contain a number |

The “is a number” function validates that a value provided is, or can be converted to a number.

In an aspect, one or more validation elements 206, 302 can represent an “is a decimal” function, for example, as illustrated below:

| Field | Value |
|---|---|
| title | Is a Decimal |
| parameters | [Media media, TargetField targetField, Integer integer] |
| description | Validates that the value provided is a decimal and has |
| | the fractional precision as indicated with the precision |
| | parameter. |
| exception | The [targetField] field must contain a decision with |
| | [integer] precision |

The “is a decimal” function can validate that the value provided is a decimal. As an example, the “is a decimal” function can validate a value with an indicated fractional precision.

In an aspect, one or more validation elements 206, 302 can represent an “evaluate number” function, for example, as illustrated below:

| Field | Value |
|---|---|
| title | Evaluate Number |
| parameters | [Media media, TargetField targetField, Operator operator, |
| | Integer integer] |
| description | Validates that the number in a field has a certain value. |
| exception | >= The field “<targetField>” must be at least <integer> |
| | > The field “<targetField>” must be more than <integer> |
| | <= The field “<targetField>” must be no more than |
| | <integer> |
| | < The field “<targetField>” must be less than <integer> |
| | = The field “<targetField>” must be exactly <integer> |
| | <> The field “<targetField>” must not be <integer> |

The “evaluate number” function can validate whether a targetField has a pre-defined size.

In an aspect, one or more validation elements 206, 302 can represent an “evaluate Boolean” function, for example, as illustrated below:

| Field | Value |
|---|---|
| title | Evaluate Boolean |
| parameters | [Media media, TargetField targetField, Boolean boolean] |
| description | Validates that a field is true or false |
| exception | The [targetField] must be [boolean] |

The “evaluate Boolean” function can validate whether a Boolean field is true or false. As an example, operators or values such as “=” and “< >” can be accepted as valid operators. However, other operators can be used.

In an aspect, one or more validation elements 206, 302 can represent “matches string” function, for example, as illustrated below:

| Field | Value |
|---|---|
| title | Matches String |
| parameters | [Media media, TargetField targetField, String regexp] |
| description | Validates that a field's String value matches a regular |
| | expression |
| exception | The [targetField] must match “[regexp]” |

The “matches string” function can validate data fields with string values and/or whether the data field matches a Java regular expression (e.g., contained in the value parameter).

In an aspect, one or more validation elements 206, 302 can represent an “evaluate categories” function, for example, as illustrated below:

| Field | Value |
|---|---|
| title | Evaluate Categories |
| parameters | [Media media, LogicalOperator logicalOp, Categories |
| | categories] |
| description | Validates a media's categories |
| exception | OR: The media must have at least one of the following |
| | categories: [list them] |
| | XOR: The media must have exactly one of the following |
| | categories: [list them] |
| | AND: The media must have all of the following categories: |
| | [list them] |
| | NONE: The media cannot have any of the following |
| | categories: [list them] |

The evaluate categories function can validate a category of a particular data such as a content or media. The “Categories” keyword can be an array of strings holding data such as a classification and title. For instance, a rule can be used that at least one category exists (using OR) or multiple categories exist (using AND) or exactly one of the entered categories exists (using XOR), or none of the categories exist (using NONE).

In an aspect, one or more validation elements 206, 302 can represent an “evaluate ratings” function, for example, as illustrated below:

| Field | Value |
|---|---|
| title | Evaluate Ratings |
| parameters | [Media media, LogicalOperator logicalOp, Ratings ratings] |
| description | Validates a media's categories |
| exception | OR: The media must have at least one of the following |
| | ratings: [list them] |
| | XOR: The media must have exactly one of the following |
| | ratings: [list them] |
| | AND: The media must have all of the following ratings: |
| | [list them] |
| | NONE: The media cannot have any of the following |
| | ratings: [list them] |

The “evaluate ratings” function can validate a rating of a data by name. The “Ratings” keyword can be an array of strings holding serialized ratings for comparison. For instance, a rule can be used that at least one rating exists (using OR) or multiple rating exist (using AND) or exactly one of the entered rating exists (using XOR), or none of the rating exist (using NONE).

In an aspect, one or more validation elements 206, 302 can represent an “evaluate availability” function, for example, as illustrated below:

| Field | Value |
|---|---|
| title | Evaluate Availability |
| parameters | [Media media, Operator operator, Integer duration] |
| description | Validates that the media is available for a particular |
| | duration by comparing the available and expiration dates. |
| exception | >=: The media must be available for at least [duration] |
| | minutes/[duration/60] hours |
| | >: The media must be available for longer than [duration] |
| | minutes/[duration/60] hours |
| | <=: The media can only be available up to [duration] |
| | minutes/[duration/60] hours |
| | <: The media cannot be available for longer than [duration] |
| | minutes/[constant/60] hours |
| | =: The media must be available exactly [duration] minutes/ |
| | [duration/60] hours |
| | In the error message, use hours if the division by 60 is a |
| | whole number, otherwise use minutes. |

The “evaluate availability” function can be applied to an availableDate and expirationDate field, for example. As a further example, the “evaluate availability” function can comprise an operator parameter and an integer such as a duration in minutes. In an aspect, the “evaluate availability” function can comprise the following function format:

EvaluateAvailability(<=, 7200)

The example above can ensures that the data (e.g., content, media) is not available for more than 5 days. The available and expiration dates can be optional. When not specified, the media can be set to default available.

In an aspect, one or more validation elements 206, 302 can be used when editing media. As an example, one or more validation elements 206, 302 can represent a read-only field or “read-only function”, for example, as illustrated below:

| Field | Value |
|---|---|
| Title | Read-Only Field |
| parameters | [Media media, ReferenceMedia refMedia, TargetField |
| | targetField] |
| description | Validates that a field's value was not edited |
| exception | The field “[targetField]” is read only |

The “read-only” function can validate or verify that a field of data (e.g., the media object) has the same value as a referenceMedia or comparator. The “read-only” function can be applied to all single data types and to collections of data. As an example, for arrays, a sets of elements may need to match. As a further example, for maps, the same key-value entries may be expected to exists in a plurality of fields.

In an aspect, the “read-only” function can have a format similar to the following example:

EvaluateAvailability(<=, 7200)

ReadOnly(availableDate)

The above example validation rules and elements can ensure that the data (e.g., media) is available for not more than 5 days and that the availableDate field cannot be moved.

In an aspect, one or more of the validation elements 206, 302 can be conditional validators. As an example, one or more validation elements 206, 302 can represent a conditional Boolean function, for example, as illustrated below:

| Field | Value |
|---|---|
| Title | Conditional Boolean |
| parameters | [Media media, TargetField targetField, Boolean |
| | boolean] |
| description | This conditional rule verifies that a field is true or false |
| returned | If the [targetField] is [boolean] |
| message | |

The conditional Boolean function can validate whether a Boolean field is true or false. If the rule evaluates to “false”, nothing may be returned, and the validation rule that depends on the conditional element may not evaluate. Otherwise, a specified message can be returned and the validation rule that depends on the conditional element can be evaluated.

In an aspect, one or more validation elements 206, 302 can represent a conditional “string match” function, for example, as illustrated below:

| Field | Value |
|---|---|
| Title | Conditional String Match |
| parameters | [Media media, TargetField targetField, String regexp] |
| description | This conditional rule validates that a field's String value |
| | matches a regular expression |
| returned | If the [targetField] matches “[regexp]” |
| message | |

The conditional “string match” function can validate fields with string values and check whether a field matches a Java regular expression, contained in the value parameter. If the rule evaluates to “false”, nothing may be returned, and the validation rule that depends on the conditional element may not evaluate. Otherwise a specified message can be returned and the validation rule that depends on the conditional element can evaluate.

In an aspect, one or more validation elements 206, 302 can represent a conditional “has value” function, for example, as illustrated below:

| Field | Value |
|---|---|
| Title | Conditional Has Value |
| parameters | [Media media, TargetField targetField, Boolean has |
| | Value] |
| description | This conditional rule validates that a field has a value |
| returned message | See below |

The conditional “has value” function can validate fields for non-null or for string values that are not empty. If the field is not null/empty and the “hasValue” flag is set to true, a return can be generated if the [targetField] has a value. Alternatively, if the field is not null/empty and the “exists” flag is set to false, a return can be generated if the [targetField] does not have a value. In other cases, the rule can evaluates to “false” and nothing may be returned.

In an aspect, one or more validation elements 206, 302 can represent a conditional categories function, for example, as illustrated below:

| Field | Value |
|---|---|
| Title | Conditional Categories |
| parameters | [Media media, LogicalOperator logicalOp, Categories |
| | categories] |
| description | This conditional rule validates a media's categories |
| returned | OR: If the media has at least one of the following |
| message | categories: [list them] |
| | XOR: If the media has exactly one of the following |
| | categories: [list them] |
| | AND: If the media has the following categories: [list them] |
| | NONE: If the media includes any of the following |
| | categories: [list them] |

The conditional categories function can validate a classification or category of a data (e.g., content, media). The “Categories” keyword can be an array of Strings holding values for category and/or title. For instance, a rule can be used that at least one category exists (using OR) or multiple categories exist (using AND) or exactly one of the entered categories exists (using XOR), or none of the categories exist (using NONE). If the rule evaluates to “false”, nothing may be returned, and the validation rule that depends on the conditional function may not evaluate. Otherwise, a specified message can be returned and the validation rule that depends on the conditional function can be evaluated.

In an aspect, one or more validation elements 206, 302 can represent a conditional ratings function, for example, as illustrated below:

| Field | Value |
|---|---|
| Title | Conditional Ratings |
| parameters | [Media media, LogicalOperator logicalOp, Ratings |
| | ratings] |
| description | This conditional rule validates a media's categories |
| returned | OR: If the media has at least one of the following ratings: |
| message | [list them] |
| | XOR: If the media has exactly one of the following |
| | ratings: [list them] |
| | AND: If the media has the following ratings: [list them] |
| | NONE: If the media includes any of the following |
| | ratings: [list them] |

The conditional ratings function can validate ratings associated with data (e.g., media, content). The “Ratings” keyword can be an array of strings holding serialized ratings data for comparison. For instance, a rule can be used that at least one rating exists (using OR) or multiple rating exist (using AND) or exactly one of the entered rating exists (using XOR), or none of the rating exist (using NONE). If the rule evaluates to “false”, nothing may be returned, and the validation rule that depends on the conditional function may not evaluate. Otherwise, a specified message can be returned and the validation rule that depends on the conditional function can be evaluated.

In an aspect, one or more validation elements 206, 302 can represent an “is valid currency” function, for example, as illustrated below:

| Field | Value |
|---|---|
| title | Is Valid Currency |
| parameters | [Media media, TargetField targetField, <Locale locale>] |
| description | Validates that a currency value is valid |
| exception | The [targetField] field contains an invalid currency |
| | ([locale]) |

The “is valid currency” function can validate whether a data field (e.g., targetField) holds a valid currency (e.g., in the passed-in Java locale). If the local is not passed-in, a default currency can be assumed.

The validation elements 206, 302 described above are for example only. One or more validation rules 207, 304, 306 can comprise, invoke, apply, and/or reference the above validation elements 206, 302 or similar elements. As an example, any validation element can be defined to verify or compare data to a pre-defined comparator, limitation, boundary, or rule. The validation elements 206, 302 are not limited to any particular data or data field and can be applied across various domains of data.

Returning to FIG. 2, in an aspect, a time element 208 can be in communication with at least the validation system 126 to provide a timing reference thereto. As an example, the time element 208 can be a clock. As a further example, the time element 208 can transmit information to the validation system 126 for associating a time stamp with a particular event received by the validation system 126. In an aspect, the validation system 126 can cooperate with the time element 208 to associate a time stamp with events having an effect on the content delivered to the CT 120 and/or the user device 124, such as, for example, a channel tune, a remote tune, remote control events, playpoint audits, playback events, program events including a program start time and/or end time and/or a commercial/intermission time, and/or playlist timing events, and the like. As an example, the validation system 126 can cooperate with the time element 208 to associate a time stamp with one or more processing steps or validations.

In an aspect, a storage device 210 can be in communication with the validation system 126 to allow the validation system 126 to store and/or retrieve data to/from the storage device 210. As an example, the storage device 210 can store data relating to a timing data 212 and/or one or more validation templates 214 relating to one or more validation elements 206 and/or validation rules 207. In an aspect, the timing data 212 can be a time stamp or other time marker for indicating a date and/or time associated with one or more of a transmission of content, a request for content, a request for playback, a storage of content, a deletion of content, and/or a state/status and/or a change in state/status of an validation. As an example, the timing data 212 can comprise any number of time-related entries and/or markers. As a further example, the timing data 212 can comprise one or more of a table of time-related data entries, a timing log, and a database of time-related information. Other information can be stored as the timing data. In an aspect, the validation templates 214 can comprise one or more validation elements 206 and/or validation rules 207. As an example, the validation templates 214 can represent a repository of retrievable validation elements 206 and/or validation rules 207 that can be retrieved by a user or device for processing. In an aspect, the validation templates 214 can comprise preconfigured scripts, code, instructions, and/or operations that can be applied to one or more data fields based upon one or more validation elements 206. As an example, a validation template 214 can implement a first one of the validation elements 206 having a first value, and, in another operation, the same validation template can implement a second one of the validation elements 206 having a second value different from the first value. In this way, the same validation template 214 can be applied in various operations and for various customized requirements. As a further example, the validation templates 214 can be pre-configured and/or classified to allow a user or device to locate a desired rule or element for retrieval.

As described in greater detail below, a system and network can be configured to control presentation of various types of content on a plurality of devices. In an aspect, data relating to the presentation of content can be processed to determine whether certain data (e.g., content) can be presented.

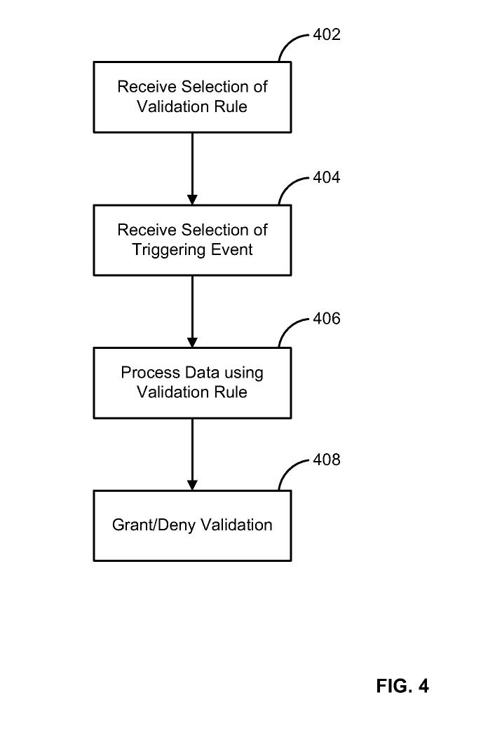

FIG. 4 illustrates a method for controlling media content presented to a user. In an aspect, in step 402, a selection of a validation rule (e.g., validation rule 207) can be received. In an aspect, the validation rule is selected and/or retrieved from the validation templates 214. As an example, the selected validation rule can comprise one or more validation elements (e.g., validation element 206). The selection of the validation rule can comprise generating a validation rule, editing a pre-existing validation rule, and/or retrieving a pre-defined validation rule. As a further example, the selected validation rule can comprise a comparison of data in a particular data field to a pre-defined validation comparator.

In step 404, a selection of a triggering event can be received. In an aspect, the triggering event can comprise an operation, a function, a user-provided feedback, a temporal event, a pre-defined event in a media lifecycle, or other detectable event. As an example, the triggering event can comprise an operation relating to the presentation of content to a user or device. As a further example, the triggering event can be associated with the validation rule selected in step 402.

In step 406, data can be processed (e.g., validated) using the validation rule and in response to the triggering event. As an example, when the selected triggering event is detected, the selected validation rule is applied to a particular data or data field in order to validate the data or related operation. If the data is validated under the selected validation rule, the data or operation is allowed (e.g., granted) to proceed, at step 408. If the data or operation is not validated, further operation may be denied, at step 408. As an example, a message can be transmitted to a device or user indicating whether the validation has been granted or denied. As a further example, a particular operation may be allowed to continue even if validation is denied; however, certain prescribed limitations may be applied to one or more data fields.

In an aspect, a warning state may be triggered based upon a failure of a validation. As an example, normal processing can continue but a warning or alert is provided to serve as a highlight to correct any problem. As a further example, a provider may prefer video content to have keywords so that end users can search for video by keyword. However, the provider can allow releasing the content to end users even if there are no keywords. Accordingly, if no keywords are validated, a validation warning can be generated, but the content can still delivered. In an aspect, a content editor can add keywords after content has already been released to end users, thus correcting the problem.

As an example, a client or user can select a particular validation rule associated with a maximum data size to be loaded into a system or memory. As a further example, the client or user can select a triggering event as the loading or storing operation. Accordingly, when a device or system processed an operation to store or load data, the selected validation rule is applied per the prescribed association with the operation. As such, if the data requested for loading is within the pre-defined rule limit, the data can be loaded/stored. Alternatively, if the data requested is outside the pre-defined rule limit, the operation can be denied and the data not loaded.

In an aspect, each validation rule (e.g., validation rules 207, 304, 306) can be a Boolean statement about a media object's metadata. For example, a validation rule can state that a media object has a value in its copyright field. When media with a copyright value is validated during an operation, the validation rule can evaluate to true and the operation is executed. However, if media with no copyright value is validated, the validation rule can evaluate to false and validation fails. When validation fails, the outcome depends on whether the validation rule is configured to result in fatal validation failures.

As described in greater detail below, a system and network can be configured to control presentation of various types of content on a plurality of devices. In an aspect, data relating to the presentation of content can be processed to determine whether certain data (e.g., content) can be presented.

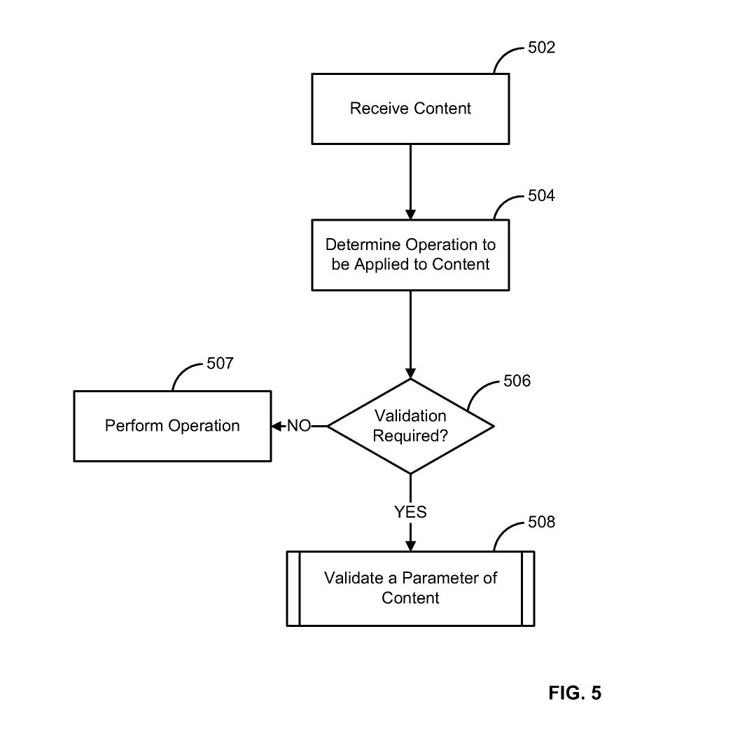

In an aspect, FIG. 5 illustrates a method for controlling media presented to a user. In an aspect, in step 502, content can be received by a device or system. As an example, the content can comprise a parameter or data field relating to the data or an operation associated with the data. As a further example, the parameter can have one or more characters, strings, arrays, and/or values attributed thereto.

In step 504, an operation can be applied to the content. In an aspect, the operation can comprise an operation associated with the lifecycle of media (e.g., converting, transmitting, receiving, rendering, storing, editing, tuning, deleting, etc.). As an example, the operation can be based upon received input or instruction (e.g., user provided input). As a further example, the operation can be any manipulation, processing, or transfer of data.

In step 506, a requirement of validation is determined In an aspect, the content is processed to determine whether any particular data fields or operations relating to the content require validation prior to executing an operation. As an example, a header, metadata, or other data relating to the content can be analyzed to determine if a requirement field or flag is present.

If no requirement is detected or indicated, the operation is allowed to proceed, at step 507. If a requirement is detected or indicated, the parameter or data field of the content relating to the requirement is validated, at step 508. In an aspect, the parameter of the content can be validated using a validation rule and in response to the operation.

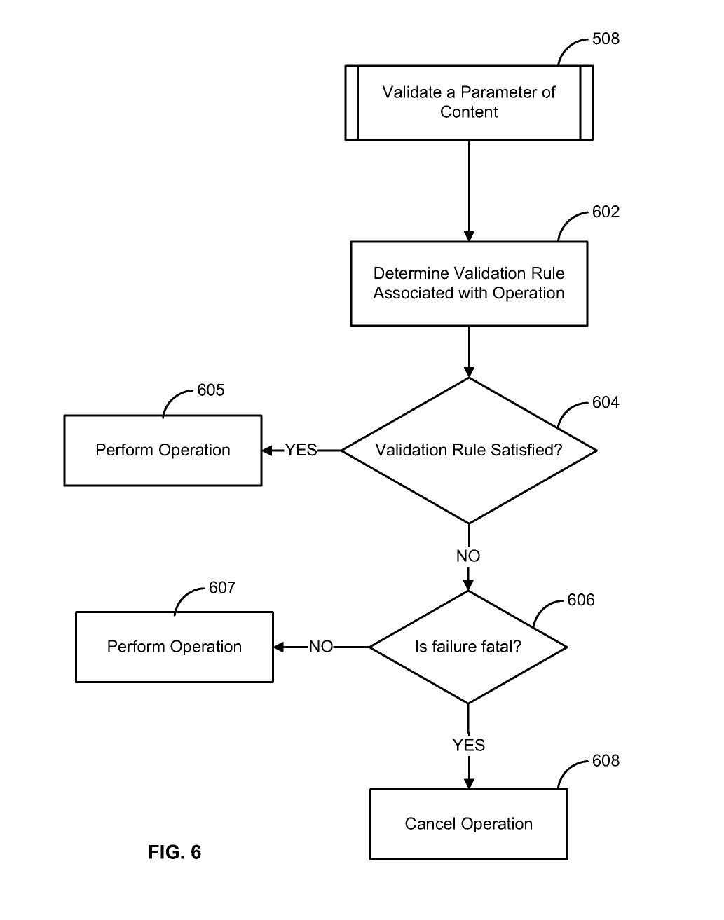

In an aspect, FIG. 6 illustrates, for example only, a method for validating a parameter or data field. In an aspect, in step 602, a validation rule and/or validation element associated with the particular parameter and/or triggering operation can be determined. As an example, an operation can comprise rendering a title of the content in a program guide of a user interface. Accordingly, a character limit validation rule associated with the rendering operation can be applied to a title data field of the content to determine whether the title exceeds a prescribed maximum length.

If the validation rule evaluates or returns a “yes” or “true” or grant type response to validation, at step 604, the operation can be performed at step 605 (e.g., the title is rendered in the program guide). In other words, if a particular data field of the content passes validation for a particular operation, the operation is allowed to proceed.

If the validation rule evaluates returns a “no” or “false” or denial type response to validation, a determination can be made regarding fatality, at step 606. As example, one or more of the validation rules can indicate whether the validation of a particular field or parameter is fatal to the related operation. If the validation is not fatal, the associated operation can be performed regardless of the validation result, at step 607. As an example, a message, alert, or warning can be transmitted in response to a denial of a non-fatal validation. If the validation is fatal and the validation rule evaluates to false, then the operation can be cancelled, at step 608. As an example, a message, alert, or warning can be transmitted in response to a denial of a fatal validation.

In an aspect, the present systems and methods can be implemented in content delivery, video content (media) creation, video content (media) updates, publishing (releasing content to end users), sharing (distributing content to other companies such as cable providers, who will in turn release the content to their end users afterwards during a separate publish process), and the like. However, other data fields and domains can implement the disclosed systems and methods.

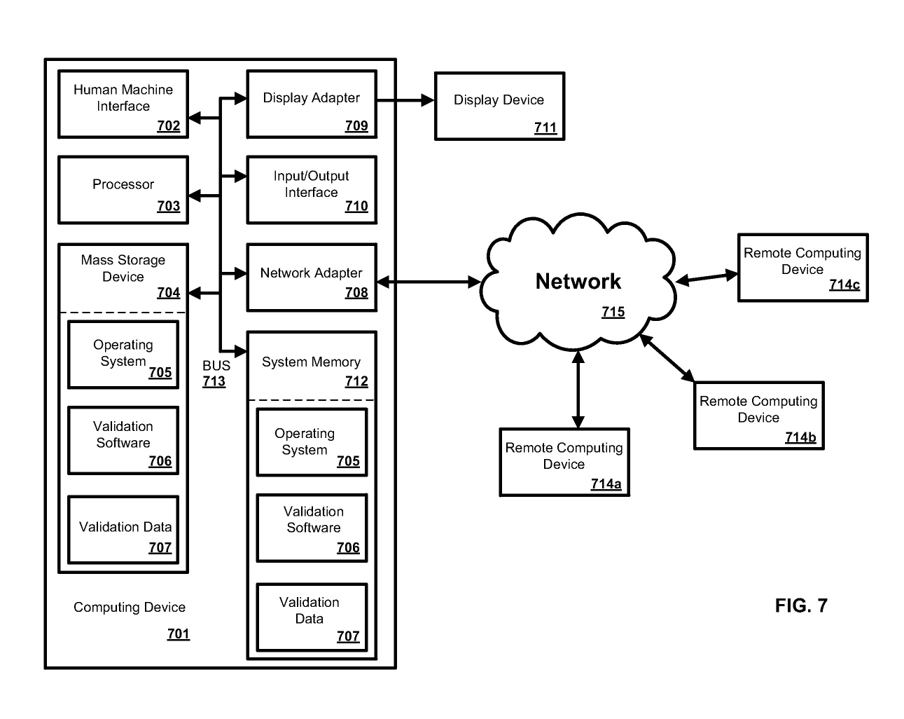

In an exemplary aspect, the methods and systems can be implemented on a computing system such as computing device 701 as illustrated in FIG. 7 and described below. By way of example, validation system 126 of FIGS. 1-2 can be a computing device as illustrated in FIG. 7. Similarly, the methods and systems disclosed can utilize one or more computers to perform one or more functions in one or more locations. FIG. 7 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 701. The components of the computer 701 can comprise, but are not limited to, one or more processors or processing units 703, a system memory 712, and a system bus 713 that couples various system components including the processor 703 to the system memory 712. In the case of multiple processing units 703, the system can utilize parallel computing.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, validation software 706, validation data 707, a network adapter 708, system memory 712, an Input/Output Interface 710, a display adapter 709, a display device 711, and a human machine interface 702, can be contained within one or more remote computing devices 714a,b,c at physically separate locations, connected through buses of this form, in effect implementing a fully distributed system.

The computing device 701 typically comprises a variety of computer readable media. Exemplary readable media can be any available media that is accessible by the computing device 701 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically contains data, such as validation data 707, and/or program modules, such as operating system 705 and validation software 706 that are immediately accessible to and/or are presently operated on by the processing unit 703.

In another aspect, the computing 701 can also comprise other removable/non-removable, volatile/non-volatile computer storage media. By way of example, FIG. 7 illustrates a mass storage device 704 which can provide non-volatile storage of computer code, computer readable instructions, data structures, program modules, and other data for the computing device 701. For example and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and validation software 706. Each of the operating system 705 and validation software 706 (or some combination thereof) can comprise elements of the programming and the validation software 706. Validation data 707 can also be stored on the mass storage device 704. Validation data 707 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 701 via an input device (not shown). Examples of such input devices comprise, but are not limited to, a keyboard, pointing device (e.g., a “mouse”), a microphone, a joystick, a scanner, visual systems, such as Microsoft's Kinect, audio systems that process sound such as music or speech, a traditional silver remote control, tactile input devices such as gloves, touch-responsive screen, body coverings, and the like These and other input devices can be connected to the processing unit 703 via a human machine interface 702 that is coupled to the system bus 713, but can be connected by other interface and bus structures, such as a parallel port, game port, an IEEE 1394 Port (also known as a Firewire port), a serial port, or a universal serial bus (USB).

In yet another aspect, a display device 711 can also be connected to the system bus 713 via an interface, such as a display adapter 709. It is contemplated that the computer 701 can have more than one display adapter 709 and the computing device 701 can have more than one display device 711. For example, a display device can be a monitor, an LCD (Liquid Crystal Display), or a projector. In addition to the display device 711, other output peripheral devices can comprise components such as speakers (not shown) and a printer (not shown) which can be connected to the computing device 701 via Input/Output Interface 710. Any step and/or result of the methods can be output in any form to an output device. Such output can be any form of visual representation, including, but not limited to, textual, graphical, animation, audio, tactile, and the like. The display 711 and computing device 701 can be part of one device, or separate devices.

The computing device 701 can operate in a networked environment using logical connections to one or more remote computing devices 714a,b,c. By way of example, a remote computing device can be a personal computer, portable computer, a smartphone, a server, a router, a network computer, a peer device or other common network node, and so on. Logical connections between the computing device 701 and a remote computing device 714a,b,c can be made via a network 715, such as a local area network (LAN) and a general wide area network (WAN). Such network connections can be through a network adapter 708. A network adapter 708 can be implemented in both wired and wireless environments. Such networking environments are conventional and commonplace in dwellings, offices, enterprise-wide computer networks, intranets, and the Internet.

For purposes of illustration, application programs and other executable program components such as the operating system 705 are illustrated herein as discrete blocks, although it is recognized that such programs and components reside at various times in different storage components of the computing device 701, and are executed by the data processor(s) of the computer. An implementation of validation software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information, such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
receiving a selection of a validation rule, the validation rule comprising a validation element;
receiving a selection of a first triggering event associated with the validation rule;
validating data using the validation rule and in response to the first triggering event;
receiving a selection of a second triggering event associated with the validation rule; and
validating the data using the validation rule and in response to the second triggering event.

2. The method of claim 1, wherein the validation element comprises a pre-defined template.

3. The method of claim 1, wherein the validation rule is associated with a particular data field to be validated.

4. The method of claim 1, wherein the first triggering event is one or more of a pre-defined time and an operation.

5. The method of claim 1, wherein the first triggering event and the second triggering event is a pre-defined events in a media lifecycle.

6. The method of claim 1, wherein the validation rule comprises a comparison of the data to a validation comparator.

7. The method of claim 1, wherein validating data further comprises applying the validation element to a data field prescribed by the validation rule.

8. A method comprising:
receiving content having a parameter;
applying a first operation to the content;
validating the parameter of the content using a validation rule and in response to the first operation, wherein the validation rule is associated with the first operation;
applying a second operation to the content; and
validating the parameter of the content using the validation rule and in response to the second operation, wherein the validation rule is associated with the second operation.

9. The method of claim 8, wherein the parameter comprises a data field defining an attribute of the content.

10. The method of claim 8, wherein the validation rule references a validation element to be applied to the parameter of the content.

11. The method of claim 8, wherein the validation rule comprises a pre-defined template.

12. The method of claim 8, wherein the first operation and the second operation are pre-defined events in a media lifecycle.

13. The method of claim 8, wherein the first operation is based upon a user-provided input.

14. The method of claim 8, wherein validating the parameter further comprises comparing the data to a validation comparator.

15. The method of claim 8, wherein validating the parameter further comprises applying the validation element to a data field prescribed by the validation rule.

16. The method of claim 8, further comprising determining whether the validation of the parameter is fatal to the performance of the operation.

17. A system comprising:
a memory storing one or more validation templates; and
at least one processor in communication with the memory, the at least one processor configured to:
receive a selection of one or more of the validation templates, wherein the validation templates comprise a validation element;
receive a selection of a first triggering event associated with the validation template;
validate data using a validation rule and in response to the first triggering event;
receive a selection of a second triggering event associated with the validation template; and
validate the data using the validation rule and in response to the second triggering event.

18. The system of claim 17, wherein the first triggering event is one or more of a pre-defined time, a pre-defined event in a media lifecycle, and an operation.

19. The system of claim 17, wherein validating data further comprises comparing the data to a validation comparator of the validation element.

20. The system of claim 17, wherein validating data further comprises applying the validation element to a data field prescribed by the validation rule.
